(19) United States
(12) Patent Application Publication
(10) Pub. No.: US 2026/0132742 A1
(43) Pub. Date: May 14, 2026

(54) ENGINE ACCESSORY MOUNTING ASSEMBLY

(71) Applicant: PRATT & WHITNEY CANADA CORP., Longueuil (CA)

(72) Inventors: Sean DOWNARD, Mississauga (CA); Ed Fazari, Etobicoke (CA); William SWITZER, Brossard (CA)

(21) Appl. No.: 18/941,404

(22) Filed: Nov. 8, 2024

(51) Int. Cl. F02C 7/20; F02C 7/18

(52) U.S. Cl. CPC F02C 7/20; F02C 7/18; F05D 2260/96

(57) ABSTRACT

A mounting assembly is provided for mounting an accessory to a casing of an aircraft engine. The assembly includes a bracket having a first end coupled to the casing, a second end coupled to the accessory, and a curved portion extending between the first end and the second end. The curved portion has a first leg and a second leg spaced by an inner volume of the bracket. A spring damper is coupled to the curved portion of the bracket. The spring damper projects into the inner volume of the bracket into contact with both the first leg and the second leg of the curved portion of the bracket.

### TECHNICAL FIELD

The application relates generally to aircraft engines and, more particularly, to mounting arrangements in aircraft engines.

### BACKGROUND

Aircraft engines may include various accessories, such as accessory gearboxes, fluid tanks and cooling manifolds. These accessories are mounted to the engine casing, for instance, via mounting arrangements comprising one or more brackets. These brackets are subjected to various dynamic and thermal loads, which may cause premature wear. Improvements are desired.

### SUMMARY

In one aspect, there is provided a mounting assembly for mounting an accessory to a casing of an aircraft engine, comprising: a bracket having a first end coupled to the casing, a second end coupled to the accessory, and a curved portion extending between the first end and the second end, the curved portion having a first leg and a second leg spaced by an inner volume of the bracket; and a spring damper coupled to the curved portion of the bracket, the spring damper projecting into the inner volume of the bracket into contact with both the first leg and the second leg of the curved portion of the bracket.

The mounting assembly described above may include any of the following features, in any combination.

In some embodiments, the spring damper is movable with at least one of the first leg and the second leg.

In some embodiments, the spring damper is configured to dampen movement of the first leg and the second leg relative to one another.

In some embodiments, the spring damper includes a wire rope isolator disposed in the inner volume of the bracket.

In some embodiments, the wire rope isolator includes a first bar, a second bar, and a looped wire coupling to the first bar to the second bar, at least one of the first bar and the second bar coupled to an inner surface of the curved portion.

In some embodiments, the spring damper includes a spring clip operatively coupled to the bracket at two locations along the curved portion.

In some embodiments, the spring clip extends from a first end to a second end, each of the first end and the second end having a retaining hook engaging an edge of the curved portion.

In some embodiments, the spring damper includes a spring-loaded pin coupled to the curved portion.

In some embodiments, the spring-loaded pin includes a head outside of the inner volume, a shaft extending through a first aperture and a second aperture in the curved portion, the shaft extending from the head at a first shaft end adjacent to the first aperture to a second shaft end adjacent to the second aperture, the second shaft end including a threaded portion engaging threading in the second aperture, the spring-loaded pin further including a spring disposed about the shaft between the head and the first aperture.

In another aspect, there is provided an aircraft engine, comprising: a turbine section having a turbine core housed within a turbine casing; a cooling system for the turbine section, the cooling system including a cooling manifold disposed around the turbine casing and a cooling conduit adapted to provide a cooling flow to the cooling manifold; brackets disposed about a circumference of the cooling manifold and coupling the cooling manifold to the turbine casing, at least one of the brackets having a having a first end coupled to the turbine casing, a second end coupled to the cooling manifold, and a curved portion extending between the first end and the second end, the curved portion having a first leg and a second leg spaced by an inner volume of the at least one of the brackets; and a spring damper coupled to the curved portion of the at least one of the brackets, the spring damper projecting into the inner volume of the at least one of the brackets into contact with both the first leg and the second leg of the curved portion of the at least one of the brackets.

The aircraft engine described above may include any of the following features, in any combination.

In some embodiments, the spring damper is movable with at least one of the first leg and the second leg.

In some embodiments, the spring damper is adapted to dampen movement of the first leg and the second leg relative to one another.

In some embodiments, the spring damper includes a wire rope isolator disposed in the inner volume of the at least one of the bracket.

In some embodiments, the wire rope isolator includes a first bar, a second bar, and a looped wire coupling to the first bar to the second bar, at least one of the first bar and the second bar coupled to an inner surface of the curved portion.

In some embodiments, the spring damper includes a spring clip operatively coupled to the at least one of the brackets at two locations along the curved portion.

In some embodiments, the spring clip extends from a first end to a second end, each of the first end and the second end having a retaining hook engaging an edge of the curved portion.

In some embodiments, the spring damper includes a spring-loaded pin coupled to the curved portion.

In some embodiments, the spring-loaded pin includes a head outside of the inner volume, a shaft extending through a first aperture and a second aperture in the curved portion, the shaft extending from the head at a first shaft end adjacent to the first aperture to a second shaft end adjacent to the second aperture, the second shaft end including a threaded portion engaging threading in the second aperture, the spring-loaded pin further including a spring disposed about the shaft between the head and the first aperture.

In a further aspect, there is provided a method for absorbing vibrations between an accessory and a casing of an aircraft engine, comprising: coupling the accessory to the casing via brackets, at least one of the brackets having a first end operatively coupled to the casing, a second end operatively coupled to the accessory, and a curved portion extending between the first end and the second end and having a first leg and a second leg spaced by an inner volume of the bracket; and coupling a spring damper to the curved portion of the at least one of the brackets, the spring damper projecting into the inner volume of the at least one of the brackets into contact with both the first leg and the second leg of the curved portion of the at least one of the brackets, to suppress vibrations between the accessory and the casing.

In some embodiments, the spring damper is movable with at least one of the first leg and the second leg.

### BRIEF DESCRIPTION OF THE DRAWINGS

Reference is now made to the accompanying figures in which:

FIG. 1 is a schematic cross sectional view of a gas turbine engine suitable for use as an aircraft engine;

FIG. 2 is a perspective view of an accessory mount for the engine of FIG. 1;

FIG. 3 is an enhanced cross sectional view of the accessory mount of FIG. 2, taken along line III-III, according to an embodiment;

FIG. 4 is a perspective view of a bracket for the accessory mount of FIG. 3;

FIG. 5 is a perspective view of a wire rope isolator for the bracket of FIG. 4;

FIG. 6 is an enhanced cross sectional view of the accessory mount of FIG. 2, taken along line III-III, according to another embodiment;

FIG. 7 is a perspective view of a bracket for the accessory mount of FIG. 6;

FIG. 8 is an enhanced cross sectional view of the accessory mount of FIG. 2, taken along line III-III, according to yet another embodiment; and

FIG. 9 is a perspective view of a bracket for the accessory mount of FIG. 8.

### DETAILED DESCRIPTION

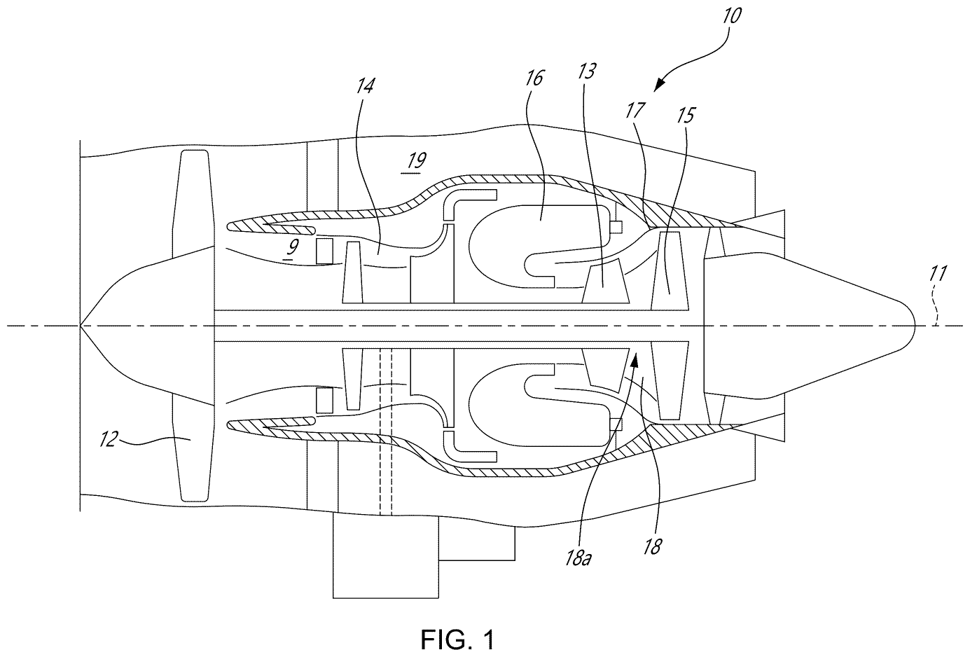

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The fan 12 propels the ambient air through an inner core 9 of the engine 10, and an outer bypass duct 19. The turbine section 18 can have a turbine or turbine core 18a which can have a high pressure turbine (HPT) 13 and a low pressure turbine (LPT) 15, both of which are housed or enclosed by a turbine casing or case 17. A longitudinal center axis 11 of the gas turbine engine 10 is also shown. While engine 10 is shown to be a turbofan gas turbine engine, the present disclosure is also directed to other engine types, such as turboprop and turboshaft engines, as well as hybrid electric engines.

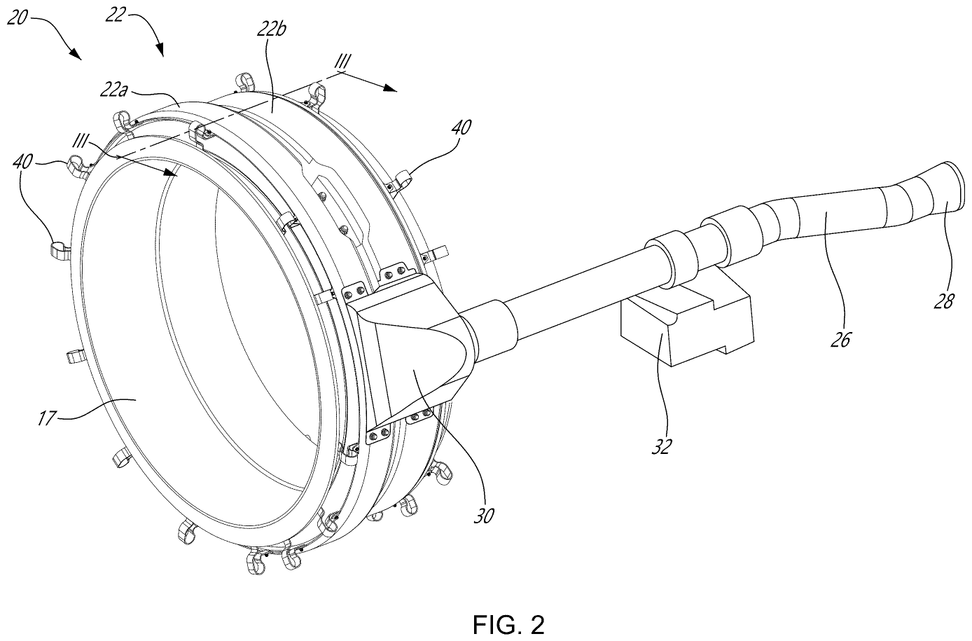

Referring to FIG. 2, an engine accessory adapted to be mounted to the engine case 17 is shown. According to the depicted example, the accessory is embodied as a cooling system 20 for cooling a part of the engine 10, such as the turbine casing or case 17. The proximity of the turbine case 17 to the working components of the turbine core 18a results in a significant heating of the turbine case 17. The cooling system 20 allows for the continuous regulation of the temperature of the turbine case 17, thus helping to maintain a control operational clearance between the turbine rotor blades of core 18a and the turbine case 17. In so doing, the cooling system 20 helps to maintain the optimum efficiency of the engine core 18a. According to some embodiments, the cooling system 20 may include the turbine case 17 and one or more cooling conduits 26, both of which will now be discussed in greater detail.

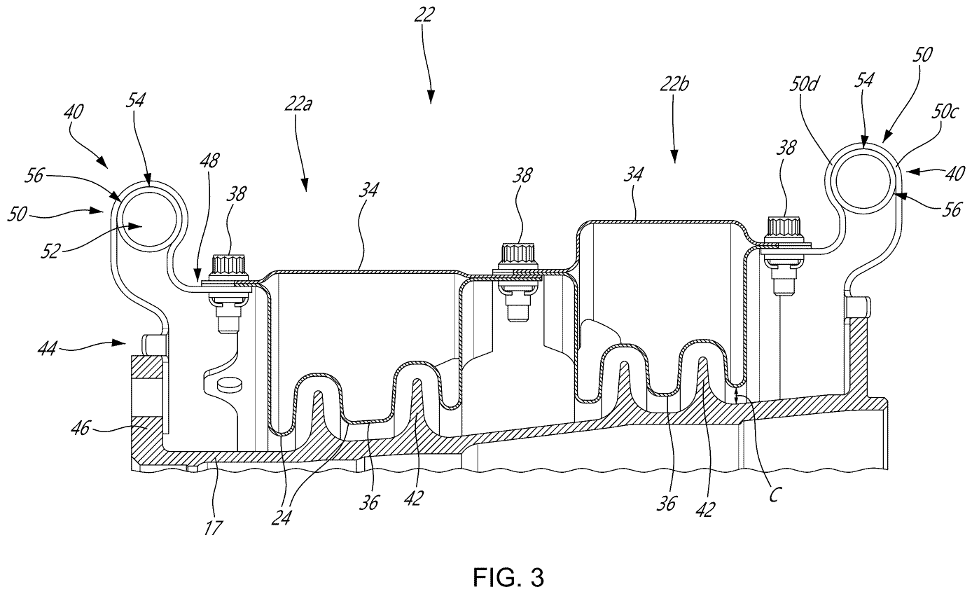

The turbine casing or case 17 extends circumferentially around the central axis and encloses some (or all) of the turbine core 18a and separates it from the bypass duct 19. Referring to FIG. 3, the turbine case 17 can have, on a radially outwardly facing surface thereof, a turbine case cooling manifold assembly 22 (or simply “cooling manifold assembly 22”), which is located radially inward from the bypass duct 19. The cooling manifold assembly 22 surrounds or envelops the case 17 and is adapted to distribute a cooling gas flow to the turbine case 17, thereby cooling the turbine case 17 and helping to maintain optimum clearance with the rotating components of the HPT 13 and LPT 15. One or more cooling manifold assemblies 22 can be used to cool the turbine case 17. For example, both the HPT 13 and the LPT 15 can each have their own cooling manifold assembly 22. In the shown example, the cooling manifold assembly 22 includes a first cooling manifold 22a and a second cooling manifold 22b, as will be described in further detail below.

In some embodiments, the cooling manifold assembly 22 has multiple apertures 24 (see FIG. 3) which are spaced apart through the cooling manifold assembly 22 about its circumference, thus surrounding the turbine case 17. The apertures 24 can distribute the cooling gas flow over the surface of the turbine case 17, thus providing a “showerhead” cooling flow to the turbine case 17. Other cooling flow distribution techniques are contemplated as well.

The cooling gas flow is supplied to the cooling manifold assembly 22 via the longitudinal cooling conduit 26. The cooling conduit 26 can be any pipe or duct which can convey the cooling gas flow from a cooling source, such as the bypass duct 19, to the cooling manifold assembly 22. The cooling conduit 26 can be a distinct component from the turbine case 17, or can extend through it. Indeed, in some embodiments, the cooling conduit 26 can be an elongated aperture extending through the turbine case 17. Although shown as substantially cylindrical, it will be appreciated that the cooling conduit 26 can take other shapes. The cooling conduit 26 has an inlet 28 which is in fluid flow communication with the bypass duct 19 such as to receive bypass air therefrom. Other sources of cooling flow may be contemplated. The cooling conduit 26 also has an outlet 30 which is in fluid flow communication with the cooling manifold assembly 22. In the shown embodiment, the flow of the cooling gas flow can be modulated by using suitable flow control devices, such as a valve 32.

Referring additionally to FIG. 3, a cross-sectional view of the cooling manifolds 22a, 22b mounted to the turbine case 17 is shown, according to an embodiment of the present disclosure. Each cooling manifold 22a, 22b includes an outer manifold body 34 and an inner manifold body 36 disposed radially inwardly of the outer manifold body 34. Each outer manifold body 34 is operatively connected to the inner manifold body 36 at various locations, illustratively via fasteners 38, as will be discussed below.

The cooling manifolds 22a, 22b are mounted to the turbine case 17 via brackets 40 with spring-like properties to allow the cooling manifolds 22a, 22b to expand under the high temperatures and to prevent high stresses from the turbine case 17 from reaching the manifold assembly 22. The brackets 40 are also adapted to govern the clearance C between the manifolds 22a, 22b and the turbine case 17. In the shown example, each cooling manifold 22a, 22b is connected to brackets 40 at a first axial end and to the other cooling manifold 22a, 22b at a second axial end, with circumferential arrays of brackets 40 extending about an outer circumference of each cooling manifold 22a, 22b (see FIG. 2). The brackets 40 are adapted to operatively couple the cooling manifolds 22a, 22b to the turbine case 17 and maintain the inner manifold bodies 36 at a radial distance (illustratively at a clearance C) from the turbine case 17 to allow the cooling flow to flow across the surface of the turbine case 17. In the shown case, the turbine case 17 includes circumferential ribs 42 extending radially outwardly therefrom, with the inner manifold bodies 36 maintaining the clearance C around the turbine case 17.

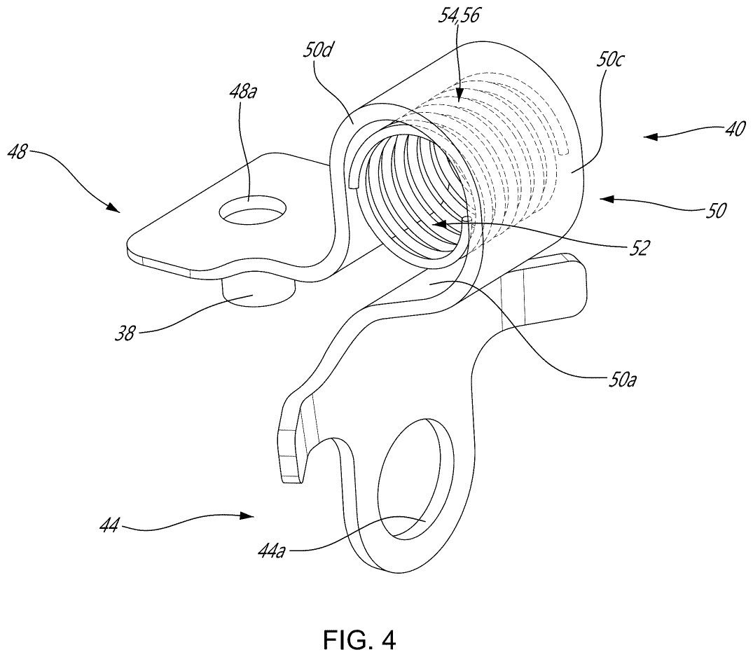

Referring additionally to FIG. 4, an exemplary bracket 40 is shown. The bracket 40 has a first end 44 couplable to the turbine case 17, illustratively a flange or support 46 protruding radially outwardly from the turbine case 17. The bracket 40 has a second end 48 extending in a plane normal to that of the first end 44 and couplable to a respective one of the cooling manifolds 22 a, 22 b, illustratively via fastener 38 at a junction between the outer manifold 34 and inner manifold 36. The bracket 40 further includes a curved portion 50 extending between the first end 44 and the second end 48, the curved portion 50 defining a partial loop at least partially enclosing an inner volume 52 of the bracket 40. The curved portion 50 includes a first leg 50c and a second leg 50d spaced apart by the inner volume 52 of the bracket 40. In the shown embodiment, the first and second ends 44, 48 include apertures 44a, 48a disposed therethrough (see FIG. 4) for attachment to the turbine case 17 and the manifolds 22a, 22b, respectively.

The brackets 40 connecting the cooling manifold assembly 22 to the turbine case 17 are provided with a sufficient degree of flexibility to avoid over-stressing and preserve the structural integrity of the cooling manifolds 22a, 22b to avoid breaking. Such flexibility is provided, for instance, by the first leg 50c and the second leg 50d of the curved portion 50 being movable relative to one another. However, the brackets 40 are subjected to various stresses under typical engine 10 operation, which over time may lead to cracks or fractures, for instance due to high cycle fatigue. Due to the high temperatures adjacent the case of the engine 10 (e.g., up to 750° F.), the brackets 40 are typically made from metal. While increasing the thickness of the brackets 40 would likely alleviate the vibration-related concerns, such an increase would decrease the flexibility of the brackets 40, potentially leading to damage to the manifolds 22a, 22b. In addition, due to the high temperatures adjacent the turbine case 17, the adjacent components are made of materials that can withstand these high temperatures, such as metal.

According to one aspect of the present disclosure, there is provided a spring damper 54, 54', 54″ to provide a dampening effect to the bracket 40 connecting the turbine case 17 to the cooling manifold 22a, 22b, thereby tuning the bracket 40 to avoid undesirable vibration frequencies. The spring damper 54, 54′, 54″ projects into the inner volume 52 of the bracket 40 into contact with both the first leg 50c and the second leg 50d, thereby dampening the movement of the first leg 50c and second leg 50d relative to one another. Stated differently, the spring damper 54, 54′, 54″ is to adapted to supress vibrations between the turbine case 17 and cooling manifolds 22a, 22b.

Various types of spring dampers 54, 54′, 54″ are disclosed, as will be discussed in further detail below. The number of spring dampers 54, 54′, 54″ may vary. In some cases, each bracket 40 along the outer circumferences of the manifolds 22a, 22b is provided with a spring damper 54, 54′, 54′′. In other cases, only brackets 40 of one of the manifolds 22a, 22b is provided with spring dampers 54, 54′, 54′′. Other configurations may be contemplated, for instance spring dampers 54, 54′, 54″ that alternate between sides of the manifold assembly 22.

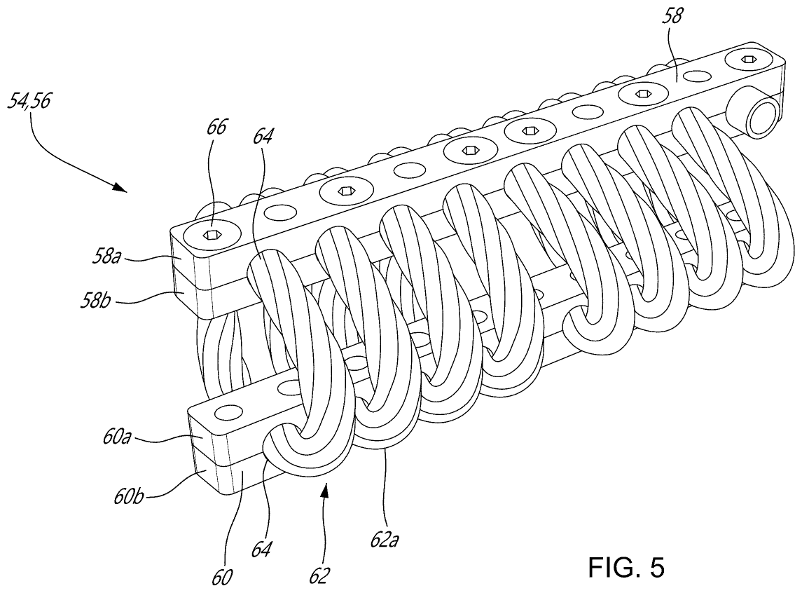

Referring additionally to FIGS. 4-5, in the shown embodiment, the spring damper 54 is a wire rope isolator 56 disposed within the inner volume 52 of a given bracket 40. The depicted wire rope isolator 56 includes a first bar 58, a second bar 60, and a looped wire 62 coupling the first bar 58 to the second bar 60. The first and second bars 58, 60 each have longitudinally spaced-apart apertures 64 extending therethrough, with the looped wire 62 extending through the apertures 64. In the shown case, the first bar 58 is formed of two plates 58a, 58b coupled to one another via fasteners 66, with cutouts through each plate 58a, 58b cooperating to form the apertures 64. Similarly, the second bar 60 is illustratively formed of two plates 60a, 60b coupled to one another via fasteners 66, with cutouts through each plate 60a, 60b cooperating to form the apertures 64. Other configurations for the bars 58, 60 may be contemplated. In embodiments, the wire rope isolator 56 is dimensioned to occupy the entirety of the inner volume 52, with the looped wire 62 abutting a radially inner surface 50a (FIG. 4) of the curved portion 50 along its entire length. One or both of the bars 58, 60 are operatively coupled to the inner surface 50a of the curved portion 50, for instance via fasteners or welding. Other coupling configurations may be contemplated.

The depicted looped wire 62 includes a plurality of individual wires 62a braided together. The number of individual wires 62a and their degree of twist may vary. The looped wire 62 is therefore adapted to absorb or dampen the various excitations experienced by the bracket 40 via Coulomb frictional damping. Stated differently, frictional forces are generated by relative movements between the individual wires 62a due to vibrations transmitted from the turbine case 17, thereby providing a dampening effect to the bracket 40 and cooling manifold assembly 22. Stated differently, the wire rope isolator 56 is adapted to modulate the displacement of the bracket 40 by providing a damping effect through friction between the individual wires 62a. The wire rope isolator 56 is therefore adapted to provide a dampening effect while maintaining the manifold assembly 22's required degree of flexibility. Various lengths, thickness and materials for the wire 62 may be contemplated, for instance for tuning to specific vibrational frequencies.

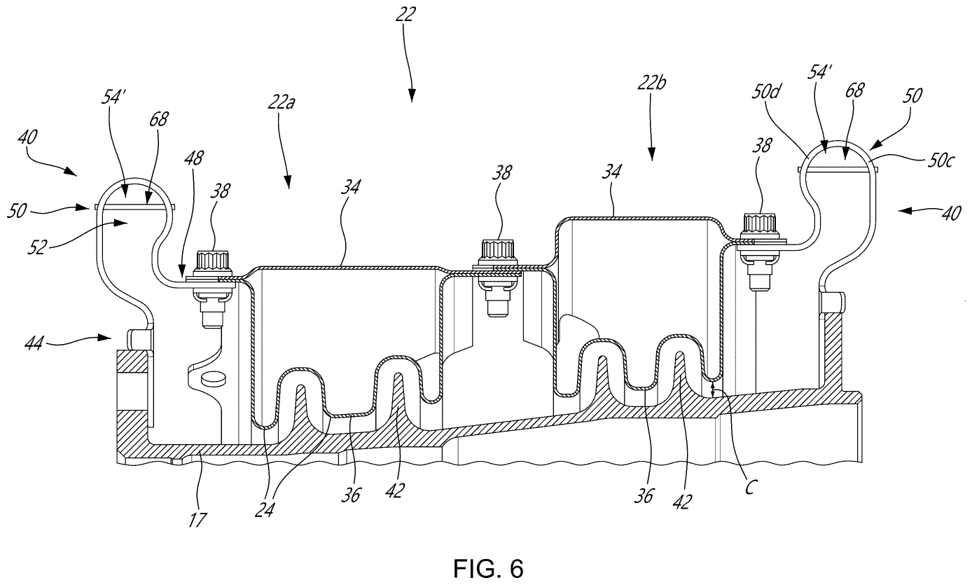

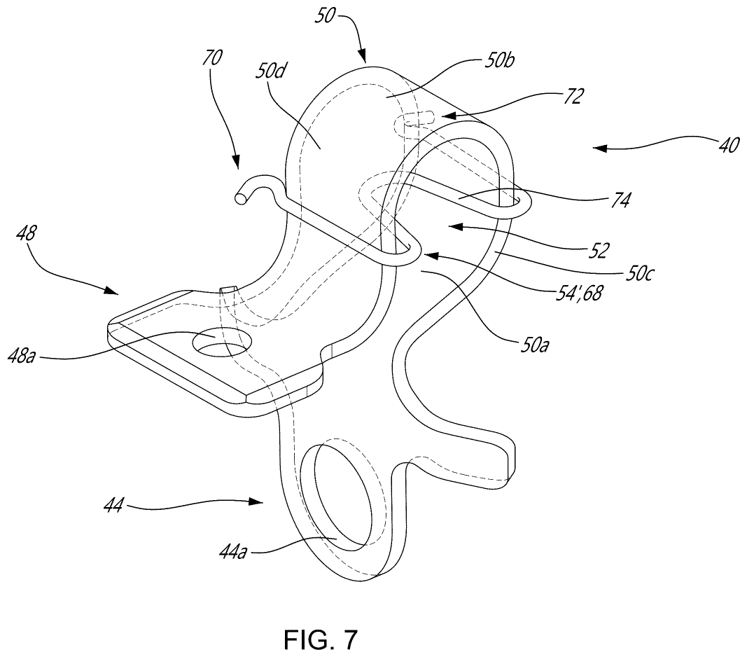

Referring to FIGS. 6-7, in accordance with another embodiment of the present disclosure, the spring damper 54′ is a spring clip 68 operatively coupled to the bracket 40 at two locations along the curved portion 50. The depicted spring clip 68 extends from a first end 70 to a second end 72 along a spring clip body 74. In the shown case, the spring clip body 74 has a cylindrical cross-sectional shape and follows a W-shaped profile, and the first and second ends 70, 72 have retaining hooks engaging an edge of the curved portion 50, although other shapes are contemplated. The spring clip body 74 engages a radially outer surface 50b of the curved portion 50 at two locations along the profile of the curved portion 50 and extends into the inner volume 52. In the present embodiment, the spring clip 68 is coated in a high temperature resistant material to withstand the high temperatures adjacent the turbine case 17 and to minimize fretting caused by metal-to-metal contact between the spring clip 68 and the bracket 40. The spring clip 68 is dimensioned to be mounted (e.g., via bending of the spring clip body 74) to be snugly received by the curved portion 50, without requiring any structural modifications to the bracket 40 to accommodate the spring clip 68. For instance, the spring clip 68 is slid into place in the inner volume 52, with minor bending of the spring clip body 74, while portions of the spring clip body 74 straddle the curved portion 50 and the hooked first and second ends 70, 72 are retained by edges of the curved portion 50. Once mounted, the spring clip 68 is adapted to provide a dampening effect and absorb vibrational energy of the bracket 40 while providing the required flexibility to the cooling manifolds 22a, 22b. Various sizes and shapes for the spring clip 68 may be contemplated, while ensuring that the spring clip 68 engages two sides of the curved portion 50 to provide the dampening effect.

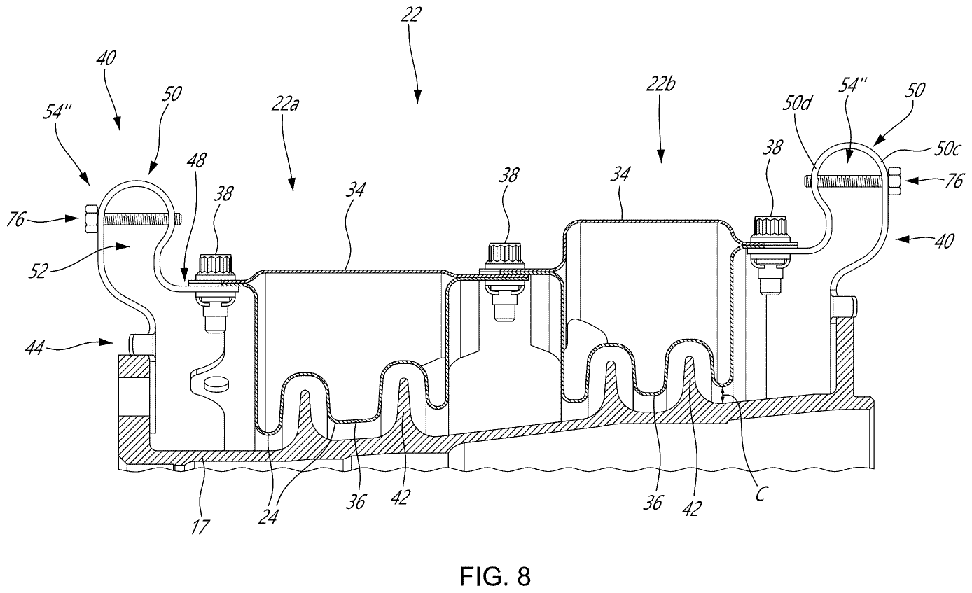

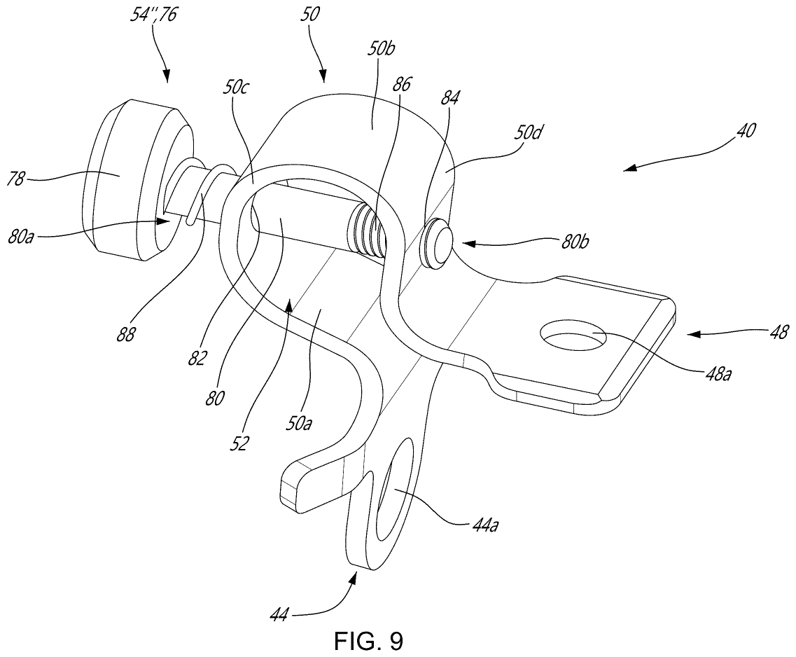

Referring to FIGS. 8-9, in accordance with yet another embodiment of the present disclosure, the spring damper 54″ is a spring-loaded pin 76 coupled to the curved portion 50 of a given bracket 40. The spring-loaded pin 76 includes a head 78 disposed outside of the inner volume 52 and a shaft 80 extending through a first aperture 82 and a second aperture 84 in the curved portion 50. In particular, the shaft 80 extends from the head 78 at a first shaft end 80a adjacent to the first aperture 82 to a second shaft end 80b adjacent to the second aperture 84. The second shaft end 80b includes a threaded portion 86 engaging threading in the second aperture 84 to secure the spring-loaded pin 76 to the bracket 40. The spring-loaded pin 76 further includes a spring 88 about the shaft 80 disposed between the head 78 and the first aperture 82 (i.e., adjacent the head 78 and outside the inner volume 52). The spring-loaded pin 76 is thus fixed to the bracket 40 at one end (i.e., at the second shaft end 80b and the second aperture 84) with a sliding joint at the other end (i.e., adjacent the fist shaft end 80a and the first aperture 82).

Under operation of the engine, displacement of the bracket 40 due to vibrations is dampened by spring-loaded pin 76 due to the compression of the spring 88 between the head 78 and the outer surface 50b of the curved portion 50. The spring-loaded pin 76 is thus adapted to modulate the displacement of the bracket 40 by providing a damping effect by way of the compressed spring 88 while maintaining the manifold assembly 22 required degree of flexibility.

According to another aspect of the present disclosure, there is provided a method for hindering vibrations between an accessory (e.g., cooling manifold assembly 22) and a casing (e.g., turbine case 17) of an aircraft engine 10. The accessory is coupled to the casing via brackets 40, at least one of the brackets 40 having a first end 44 operatively coupled to the casing, a second end 48 operatively coupled to the accessory, and a curved portion 50 extending between the first end 44 and the second end 48 and having a first leg 50c and a second leg 50d spaced by an inner volume 52 of the bracket 40. A spring damper 54, 54′, 54″ is coupled to the curved portion 50 of the at least one of the brackets 40, the spring damper 54, 54′, 54″ projecting into the inner volume 52 of the at least one of the brackets 40 into contact with both the first leg 50c and the second leg 50d of the curved portion 50 of the at least one of the brackets 40, to absorb vibrations between the accessory and the casing.

According to some aspects, the present disclosure provides for dampening of brackets 40 coupling a cooling manifold assembly 22 to a turbine case 17 to provide sufficient flexibility to the cooling manifold assembly 22 while dampening vibrations in the brackets 40, thereby striking a balance between dynamics and stresses. Advantageously, the above-described spring dampers 54, 54′, 54″ are adapted to be coupled to brackets 40 used to mount the cooling manifold assembly 22 to the turbine case 17 with little to no modifications required to the existing brackets 40. The proposed solutions can thus be retrofitted to existing brackets that have already been installed on field engines.

The above-disclosed spring dampers 54, 54′, 54″ are described as being provided for use in brackets 40 coupling a cooling manifold assembly 22 to a turbine case 17. However, it is understood that the spring dampers 54, 54′, 54″ are implementable in other mounting arrangements, for instance to mount other engine accessories such as air, fuel or oil tubes, to the casing of the engine 10. Other locations for the above-disclosed spring dampers 54, 54′, 54″ may be contemplated where an engine bracket requires dampening without increased stiffness.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A mounting assembly for mounting an accessory to a casing of an aircraft engine, comprising:
a bracket having a first end coupled to the casing, a second end coupled to the accessory, and a curved portion extending between the first end and the second end, the curved portion having a first leg and a second leg spaced by an inner volume of the bracket; and
a spring damper coupled to the curved portion of the bracket, the spring damper projecting into the inner volume of the bracket into contact with both the first leg and the second leg of the curved portion of the bracket.

2. The mounting assembly as defined in claim 1, wherein the spring damper is movable with at least one of the first leg and the second leg.

3. The mounting assembly as defined in claim 1, wherein the spring damper is configured to dampen movement of the first leg and the second leg relative to one another.

4. The mounting assembly as defined in claim 1, wherein the spring damper includes a wire rope isolator disposed in the inner volume of the bracket.

5. The mounting assembly as defined in claim 4, wherein the wire rope isolator includes a first bar, a second bar, and a looped wire coupling to the first bar to the second bar, at least one of the first bar and the second bar coupled to an inner surface of the curved portion.

6. The mounting assembly as defined in claim 1, wherein the spring damper includes a spring clip operatively coupled to the bracket at two locations along the curved portion.

7. The mounting assembly as defined in claim 6, wherein the spring clip extends from a first end to a second end, each of the first end and the second end having a retaining hook engaging an edge of the curved portion.

8. The mounting assembly as defined in claim 1, wherein the spring damper includes a spring-loaded pin coupled to the curved portion.

9. The mounting assembly as defined in claim 8, wherein the spring-loaded pin includes a head outside of the inner volume, a shaft extending through a first aperture and a second aperture in the curved portion, the shaft extending from the head at a first shaft end adjacent to the first aperture to a second shaft end adjacent to the second aperture, the second shaft end including a threaded portion engaging threading in the second aperture, the spring-loaded pin further including a spring disposed about the shaft between the head and the first aperture.

10. An aircraft engine, comprising:
a turbine section having a turbine core housed within a turbine casing;
a cooling system for the turbine section, the cooling system including a cooling manifold disposed around the turbine casing and a cooling conduit adapted to provide a cooling flow to the cooling manifold;
brackets disposed about a circumference of the cooling manifold and coupling the cooling manifold to the turbine casing, at least one of the brackets having a having a first end coupled to the turbine casing, a second end coupled to the cooling manifold, and a curved portion extending between the first end and the second end, the curved portion having a first leg and a second leg spaced by an inner volume of the at least one of the brackets; and
a spring damper coupled to the curved portion of the at least one of the brackets, the spring damper projecting into the inner volume of the at least one of the brackets into contact with both the first leg and the second leg of the curved portion of the at least one of the brackets.

11. The aircraft engine as defined in claim 10, wherein the spring damper is movable with at least one of the first leg and the second leg.

12. The aircraft engine as defined in claim 10, wherein the spring damper is adapted to dampen movement of the first leg and the second leg relative to one another.

13. The aircraft engine as defined in claim 10, wherein the spring damper includes a wire rope isolator disposed in the inner volume of the at least one of the bracket.

14. The aircraft engine as defined in claim 13, wherein the wire rope isolator includes a first bar, a second bar, and a looped wire coupling to the first bar to the second bar, at least one of the first bar and the second bar coupled to an inner surface of the curved portion.

15. The aircraft engine as defined in claim 10, wherein the spring damper includes a spring clip operatively coupled to the at least one of the brackets at two locations along the curved portion.

16. The aircraft engine as defined in claim 15, wherein the spring clip extends from a first end to a second end, each of the first end and the second end having a retaining hook engaging an edge of the curved portion.

17. The aircraft engine as defined in claim 10, wherein the spring damper includes a spring-loaded pin coupled to the curved portion.

18. The aircraft engine as defined in claim 17, wherein the spring-loaded pin includes a head outside of the inner volume, a shaft extending through a first aperture and a second aperture in the curved portion, the shaft extending from the head at a first shaft end adjacent to the first aperture to a second shaft end adjacent to the second aperture, the second shaft end including a threaded portion engaging threading in the second aperture, the spring-loaded pin further including a spring disposed about the shaft between the head and the first aperture.

19. A method for absorbing vibrations between an accessory and a casing of an aircraft engine, comprising:
coupling the accessory to the casing via brackets, at least one of the brackets having a first end operatively coupled to the casing, a second end operatively coupled to the accessory, and a curved portion extending between the first end and the second end and having a first leg and a second leg spaced by an inner volume of the bracket; and
coupling a spring damper to the curved portion of the at least one of the brackets, the spring damper projecting into the inner volume of the at least one of the brackets into contact with both the first leg and the second leg of the curved portion of the at least one of the brackets, to suppress vibrations between the accessory and the casing.

20. The method as defined in claim 19, wherein the spring damper is movable with at least one of the first leg and the second leg.
